(19) United States
(12) Patent Application Publication
(10) Pub. No.: US 2022/0146360 A1
(43) Pub. Date: May 12, 2022

(54) SOUND DETECTION DEVICE FOR WATER AND SEWAGE PIPE, WATER LEAKAGE MONITORING SERVER, AND WATER LEAKAGE DETECTION SYSTEM INCLUDING SAME

(71) Applicant: USOL CO., LTD., Daejeon (KR)

(72) Inventor: Kwang Suhk OH, Sejong-si (KR)

(21) Appl. No.: 17/479,091

(22) Filed: Sep. 20, 2021

(30) Foreign Application Priority Data
Nov. 6, 2020 (KR) 10-2020-0147677

(51) Int. Cl. G01M 3/24; G01M 3/00

(52) U.S. Cl. CPC G01M 3/243; G01M 3/002

(57) ABSTRACT

A water leakage monitoring system for a water and sewage pipe is provided. The water leakage monitoring system includes a plurality of sound detection devices installed in the water and sewage pipe to be spaced apart from each other, configured to operate for a predetermined operation time to detect a sound of water flowing inside the water and sewage pipe, and to record the sound of water for the predetermined recording time when a water leakage sound is detected during a detection operation, and a water leakage monitoring server configured to receive water leakage information including the recorded sound of water from a pair of neighboring sound detection devices detecting a water leakage sound among the plurality of sound detection devices and to generate detailed water leakage information by using the received water leakage information.

### CROSS REFERENCE TO RELATED APPLICATION

The present application claims priority to Korean Patent Application No. 10-2020-0147677 filed on Nov. 6, 2020, which application is incorporated herein by reference in its entirety.

### BACKGROUND

### 1. Field of the Invention

The present disclosure relates to a sound detection device for a water and sewage pipe, a water leakage monitoring server, and a water leakage detection system including the same and, more specifically, to a sound detection device for a water and sewage pipe to efficiently detect and monitor water leakage of the water and sewage pipe by the sound of water, a water leakage monitoring server, and a water leakage detection system including the same.

### 2. Description of the Related Art

In general, tap water is supplied after water purification at a water purification plant. A water pipeline for supplying water from the water purification plant to a water meter of a consumer is configured to allow water to pass therethrough to stably supply tap water and a sewage pipeline for discharging the water used by the consumer is configured to allow sewage to pass therethrough.

Since water is an indispensable element in human life, the water pipeline and the sewage pipeline are essential infrastructures of living facilities including cities. Such a water and sewage pipe transfers tap water through a pipe connected from the water purification plant and mainly have the form of being buried underground.

For this reason, there is a problem in that it is not possible to accurately determine the state of the water and sewage pipe when they are damaged or aged. When the water and sewage pipe is damaged, water leakage occurs to bring economical loss. When the aged pipe is unmaintained, rust may occur and contaminants may penetrate through a damaged portion, and thus problems are generated in water quality management.

To solve water quality management problems, a subject that manages a water and sewage pipe uses a method of sequentially replacing the aged pipes in accordance with an installation date of the water and sewage pipe. However, damage to the water and sewage pipe is not necessarily proportional to aging conditions. The condition of water and sewage pipe also differs significantly depending on the condition of the land in which the pipes are buried. Therefore, the method of sequentially replacing the aged pipes does not select and replace only the damaged water and sewage pipe but rather all the pipes, thereby being a very undesirable method in terms of economic efficiency and efficiency.

Accordingly, methods for finding the location where damage has occurred directly in the water and sewage pipe and replacing only the damaged pipe have been proposed. For example, there is a method of attaching a sound sensor to the outer circumferential surface of the water and sewage pipe to detect a sound generated by the flow of water.

The method was inspired by the fact that the sound of water changes when water leakage occurs and has the advantage of easy installation, but the sound sensor is installed on the outer circumferential surface of the water and sewage pipe, and thus sound detection is greatly affected depending on the thickness and material of the pipe. Accordingly, the method has a problem in that it is difficult to accurately measure the sound.

### DOCUMENTS OF RELATED ART

(Patent Document 1) Korean Patent Registration No. 10-1107085 (published on Jan. 11, 2012)

### SUMMARY

To solve the described problems, an objective of the present disclosure is to provide a sound detection device for a water and sewage pipe, which uses the sound of water flowing inside the water and sewage pipe to correctly detect water leakage and check information related to the water leakage to efficiently monitor the water leakage, a water leakage monitoring server, and a water leakage detection system including the same.

The problems to be solved of the present disclosure are not limited to those mentioned above, and other problems not mentioned will be clearly understood by those skilled in the art from the following description.

As a means for solving the described technical objective, a sound detection device for a water and sewage pipe according to another embodiment of the present disclosure includes: an underwater sound sensor configured to detect the sound of water in the water and sewage pipe; a temperature sensor configured to measure the temperature of water; and a controller configured to control the underwater sound sensor and the temperature sensor to operate during a predetermined operation time and to record the sound of water detected by the underwater sound sensor for the predetermined recording time when a water leakage sound is detected during a detection operation.

A plurality of sound detection devices may be respectively installed in the water and sewage pipes to be spaced apart from each other.

The controller may generate water leakage information including the recorded sound of water, the measured water temperature, and the recording time of the sound of water and may transmit the generated water leakage information to an external server.

The sound detection device may further include a plurality of sub pipes having one end fixed in a hole which is formed on one side of the water and sewage pipe to be spaced apart from each other and allowing a valve to be installed at the other end.

The sound detection device may be installed at the other end of the sub pipe while the valve is closed and the valve may be left open after installation of the sound detection device.

A water leakage monitoring server for a water and sewage pipe according to another embodiment of the present disclosure includes: a network interface unit configured to receive the water leakage information from a sound detection device detecting a water leakage sound among the plurality of sound detection devices installed in the water and sewage pipe; an information generation unit configured to generate detailed water leakage information by using the received water leakage information; and a synchronization unit collectively synchronizing the time of the plurality of sound detection devices in accordance with a predetermined period.

The information generation unit may compute a water leakage point by using the received water leakage information, mark the computed water leakage point on a water and sewage pipe map to generate map information, and include the generated map information in the detailed water leakage information.

The information generation unit may check the speed when the water leakage sound is transferred to the sound detection device in consideration of the water temperature included in the water leakage information and may compute a difference in time when the water leakage sound is transferred to the plurality of sound detection devices on the basis of cross-correlation to determine a water leakage point.

A water leakage monitoring system for a water and sewage pipe according to another embodiment of the present disclosure includes: a plurality of sound detection devices installed in the water and sewage pipe to be spaced apart from each other, configured to operate for a predetermined operation time to detect a sound of water flowing inside the water and sewage pipe, and to record the sound of water for the predetermined recording time when a water leakage sound is detected during a detection operation; and a water leakage monitoring server receiving water leakage information including the recorded sound of water from a pair of neighboring sound detection devices detecting the water leakage sound among the plurality of sound detection devices and using the received water leakage information to generate detailed water leakage information.

The sound detection device may include: an underwater sound sensor configured to detect the sound of water in the water and sewage pipe; a temperature sensor configured to measure the temperature of water; and a controller configured to control the underwater sound sensor and the temperature sensor to operate during the predetermined operation time and to record the sound of water detected by the underwater sound sensor for the predetermined recording time when the water leakage sound is detected during a detection operation.

The water leakage monitoring server may compute a water leakage point by using the received water leakage information, mark the computed water leakage point on a water and sewage pipe map to generate map information, and include the generated map information in the detailed water leakage information.

The controller may generate water leakage information including the recorded sound of water, the measured water temperature, and the recording time of the sound of water and may transmit the generated water leakage information to the water leakage monitoring server.

The controller may record the sound of water upon the predetermined recording time when the water leakage sound is detected by the underwater sound sensor.

The water leakage monitoring server may collectively synchronize the time of the controllers in accordance with a predetermined period.

The water leakage monitoring server may check the speed when the water leakage sound is transferred to the sound detection device in consideration of the water temperature included in the water leakage information and may compute a difference in time when the water leakage sound is transferred to the plurality of sound detection devices on the basis of cross-correlation to determine a water leakage point.

The sound detection device may further include a plurality of sub pipes having one end fixed in a hole, which is formed on one side of the water and sewage pipe, to be spaced apart from each other and allowing a valve to be installed at the other end.

The sound detection device may be installed at the other end of the sub pipe while the valve is closed and the valve may be left open after installation of the sound detection device.

The present disclosure provides a sound detection device for a water and sewage pipe, which may use an underwater sound sensor capable of detecting a sound by using water as a medium and check pieces of concrete information related to water leakage on the basis of information acquired from a water leakage sound detected by the underwater sound sensor, a water leakage monitoring server, and a water leakage monitoring system including the same.

Accordingly, a point where water leakage occurs is checked and informed to a manager when the water leakage occurs in a water and sewage pipe, thereby providing an effect of preventing unnecessary replacement of the water and sewage pipe and minimizing accidents and damages due to the water leakage.

Effects of the present disclosure are not limited to those mentioned above, and other effects not mentioned will be clearly understood by those skilled in the art from the following description.

### BRIEF DESCRIPTION OF THE DRAWINGS

FIG. 1 is a network configuration diagram of a water leakage monitoring system for a water and sewage pipe according to a preferred embodiment of the present disclosure;

FIG. 2 is a block diagram of a sound detection device according to a preferred embodiment of the present disclosure;

FIG. 3 is a view illustrating an example of installation of a sound detection device according to a preferred embodiment of the present disclosure;

FIG. 4 is a view showing another installation example of a sound detection device according to a preferred embodiment of the present disclosure;

FIG. 5 is a block diagram of a water leakage monitoring server according to a preferred embodiment of the present disclosure;

FIGS. 6A and 6B are views illustrating a state when no water leakage occurs in the water and sewage pipe;

FIGS. 7A and 7B are views illustrating the state in a non-operation time of the sound detection device when water leakage occurs in the water and sewage pipe; and

FIGS. 8A and 8B are views illustrating the state of the sound detection device in an operation time when water leakage occurs in the water and sewage pipe.

### DETAILED DESCRIPTION

The above objects, other objects, features, and advantages of the present disclosure will be easily understood through the following preferred embodiments in conjunction with the accompanying drawings. However, the present disclosure is not limited to the embodiments described herein and may be embodied in other forms. Rather, the embodiments introduced herein are provided so that the disclosed content may be thorough and complete, and that the spirit of the present disclosure may be sufficiently conveyed to those skilled in the art.

In this specification, when a component is referred to as being on another component, it may be directly formed on the other component or a third component may be interposed therebetween. In addition, in the drawings, the thickness of the components is exaggerated for the effective description of the technical content.

When it is stated that any element, component, device, or system includes a component consisting of a program or software, even if not explicitly stated, it should be understood that the element, component, device, or system includes hardware (e.g., memory, CPU, etc.) or other programs or software (e.g., drivers necessary to run an operating system or hardware) necessary for execution or operation.

In addition, it should be understood that an element (or component) may be implemented in software, hardware, or in any form of software and hardware, unless otherwise specified in implementation of the element (or component).

In addition, the terminology used herein is for the purpose of describing the embodiments and is not intended to limit the present disclosure. In this specification, the singular also includes the plural unless specifically stated otherwise in the phrase. As used herein, the terms ‘comprises’ and/or ‘comprising’ do not exclude the presence or addition of one or more other components.

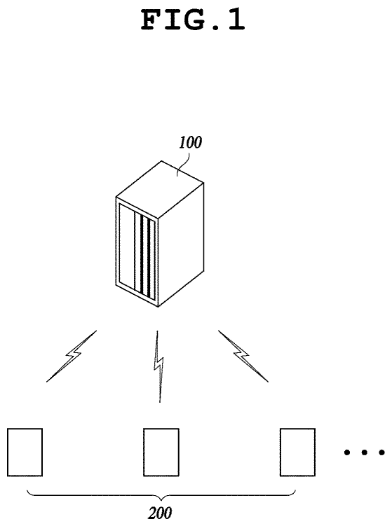

FIG. 1 is a network configuration diagram of a water leakage monitoring system for a water and sewage pipe according to a preferred embodiment of the present disclosure

As shown, the water leakage monitoring system for a water and sewage pipe according to a preferred embodiment of the present disclosure includes a water leakage monitoring server 100 and a plurality of sound detection devices 200, which are connected to each other to enable communications through a wireless communication network.

When the sound detection device 200 detects water leakage in the water and sewage pipe, the water leakage monitoring server 100 uses information acquired by water leakage detection to extract and compute detailed information related to the water leakage.

The information acquired by the water leakage detection in the sound detection device 200 is referred to as water leakage information. The water leakage information includes the recorded sound of water, the temperature of water, and recording time of the sound of water. The water leakage monitoring server 100 receives the water leakage information from the sound detection device 200 and uses the same to extract and compute the detailed information related to the water leakage. At this time, the detailed information related to the water leakage generated by the water leakage monitoring server 100 is referred to as detailed water leakage information. The detailed water leakage information includes information about the point where the water leakage occurred together with the water leakage information.

When using the water leakage information to compute a water leakage point, the water leakage monitoring server 100 may compute data transmitted from a plurality of sound detection devices detecting a water leakage sound through a time difference analysis on the basis of well-known cross-correlation and may check a correct water leakage position through sound speed compensation in accordance with the temperature of water.

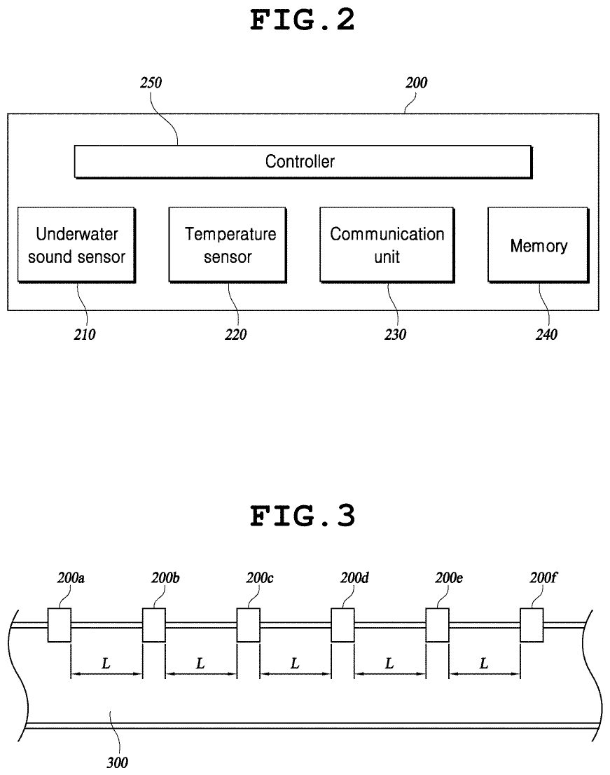

The water leakage monitoring server 100 performs communications with the plurality of sound detection devices 200 installed in the water and sewage pipe through the wireless network to transmit and receive information mutually. The water leakage monitoring server 100 will be explained in detail in the following FIG. 2.

The sound detection device 200 is installed to be spaced apart from the water and sewage pipe. In other words, the plurality of sound detection devices 200 are installed in the water and sewage pipe at one point and perform wireless communications with the water leakage monitoring server 100 and installation intervals thereof are experimentally set to be in an efficient operation range when performing operation required for water leakage detection. An installation example of the sound detection device 200 will be explained in detail in FIG. 3.

Moreover, the sound detection device 200 is operated for a predetermined operation time to detect the sound of water flowing inside the water and sewage pipe and records the sound of water during the recording time when a water leakage sound is detected during a detection operation. The sound detection device 200 performing such operation will be explained in detail in the following FIG. 2.

FIG. 2 is a block diagram of a sound detection device according to a preferred embodiment of the present disclosure.

Referring to FIG. 2, the sound detection device 200 according to a preferred embodiment of the present disclosure includes an underwater sound sensor 210, a temperature sensor 220, a communication unit 230, a memory 240, and a controller 250. The sound detection device 200 illustrated in the embodiment is a common configuration of the sound detection device 200 illustrated in FIG. 1.

The underwater sound sensor 210 detects the sound of the water flowing in the water and sewage pipe. As the underwater sound sensor 210, various sound sensors, such as a microphone, capable of detecting a sound can be applied, but a type capable of being used in the water should be applied necessarily.

The underwater sound sensor 210 utilizes the water flowing inside the water and sewage pipe as a medium to detect a sound and has an advantage of securing a constant detection performance regardless of the type of the water and sewage pipe.

The temperature sensor 220 measures the temperature of the water flowing inside the water and sewage pipe. The temperature sensor 220 should be installed adjacent to the underwater sound sensor 210. The temperature sensor 220 is applied to the sound detection device because the transfer speed of the sound is changed in accordance with the temperature of water.

More specifically, the transfer speed of water is 1,433 m/sec in the water of 15° C. and 1,483 m/sec in the water of 20° C. and shows the form that the transfer speed is increased by 4.6 m/sec whenever the temperature is increased by 1° C. Therefore, the speed when the water leakage sound is transferred should be known to find out a correct water leakage point in the water leakage monitoring server 100 and the temperature of water at the point of time when the water leakage sound occurs should be known to check the correct speed when the water leakage sound is transferred. As such, as the speed when the water leakage sound is transferred is changed depending on the temperature of water, the water leakage monitoring server 100 may check the speed when the water leakage sound is transferred to the sound detection device 200 in consideration of the water temperature included in the water leakage information.

The communication unit 230 supports wireless communications to allow the sound detection device 200 to communicate with the water leakage monitoring server 100. For example, the communication unit 230 may transmit the water leakage information to the water leakage monitoring server 100 under control of the controller 255 to be described later and may receive time information during a time synchronization operation by the water leakage monitoring server 100.

In the present embodiment, the form in which each communication unit 230 is provided for each sound detection device 200 has been exemplified, but this is for convenience of configuration and description and design changes are possible if necessary. For example, the form in which a small number (e.g., three to four) of the sound detection devices 200 are grouped and one communication unit 230 is connected to each group by wire is also possible.

The memory 240 stores information required for operation of the sound detection device 200. For example, the memory 240 stores the time information when the water leakage monitoring server 100 transmits the time information for time synchronization. Moreover, the sound detection device 200 is not continuously operated, the memory 240 stores operation time when the sound detection device 200 should be operated.

The controller 250 controls the overall function of the sound detection device 200. The controller 250 performs control to allow the underwater sound sensor 210 and the temperature sensor 230 to operate during the predetermined operation time. In other words, the controller 250 prevents the underwater sound sensor 210 and the temperature sensor 230 from operating during non-operation time.

Moreover, the controller 250 records the sound of water during the predetermined recording time when detecting the water leakage sound detected by the underwater sound sensor 210. Then, the controller 250 generates the water leakage information including the recorded sound of water acquired by the underwater sound sensor 210, the water temperature acquired by the temperature sensor 220, and the recording time of the sound of water stored in the memory 240.

FIG. 3 is a view illustrating an example of installation of a sound detection device according to a preferred embodiment of the present disclosure.

The plurality of sound detection devices are applied to the water leakage detection system for a water and sewage pipe. The plurality of sound detection devices 200 are directly installed in a water and sewage pipe 300 to be spaced apart at predetermined installation intervals.

The plurality of sound detection devices 200 are directly installed in the water and sewage pipe 300 to detect the sound and temperature of the water flowing inside the water and sewage pipe 300 and are spaced apart from each other.

As shown, the sound detection devices 200a-200f are installed in the water and sewage pipe 300 to be spaced apart from each other and, in the present embodiment, are disposed at regular intervals, wherein the interval is indicated as L. For example, L may be 1 Km.

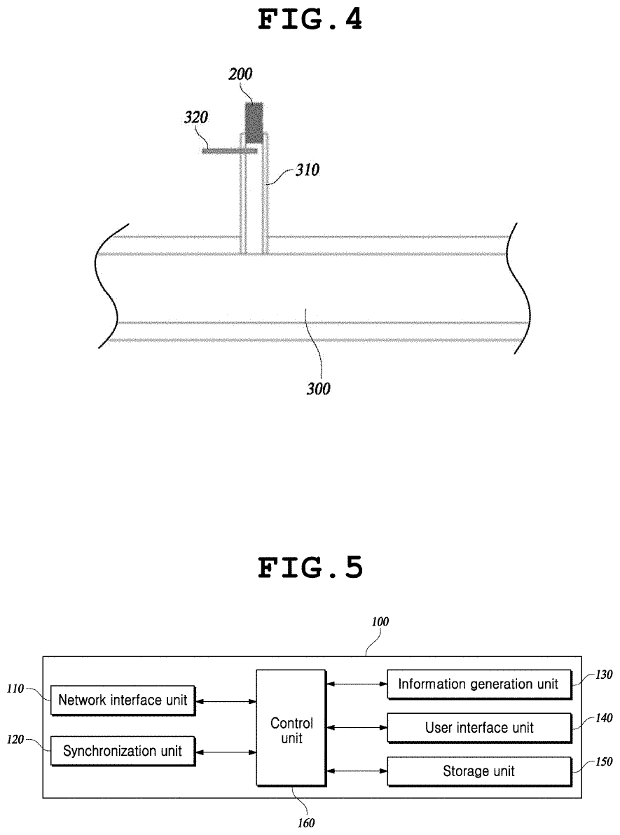

FIG. 4 is a view showing another installation example of a sound detection device according to a preferred embodiment of the present disclosure.

The previous embodiment illustrates the state that the sound detection device 200 is directly installed in a perforated point of the water and sewage pipe 300, but the present embodiment illustrates that the sound detection device 200 is installed through a sub pipe 310 without being directly installed in the water and sewage pipe 300.

As shown, one side of the water and sewage pipe 300 is perforated and the sub pipe 310 perpendicular to the water and sewage pipe 300 is installed in the perforated portion. In other words, one side of the sub pipe 310 is connected to the perforated portion of the water and sewage pipe 300 and the sound detection device 210 is installed on the other side.

At this time, a valve 320 capable of preventing water from flowing is installed on the other side of the sub pipe 310 in which the sound detection device 200 is installed. In other words, the valve 320 is interposed between the sub pipe 310 and the sound detection device 200.

At this time, attention should be paid to the installation sequence when installing the sub pipe 310 to the water and sewage pipe 300. When the sub pipe 310 connected to the valve 320 is connected to the water and sewage pipe 300, the sub pipe 310 is connected to the perforated portion of the water and sewage pipe 300 in the state that the valve 320 is closed. Then, the sound detection device 200 is installed at an end part of the sub pipe 310 on a side in which the valve 320 is installed and the valve 320 is opened to allow the water of the water and sewage pipe 300 to flow in the sub pipe 310, and thus the water comes in contact with the sound detection device 200.

Such a structure should be identically applied to the plurality of sound detection devices installed in the water and sewage pipe 300. As such, even in the form that the sound detection device 200 is installed in the sub pipe 310, the intervals between the sound detection devices 200 should be constantly maintained.

FIG. 5 is a block diagram of a water leakage monitoring server according to a preferred embodiment of the present disclosure.

Referring to FIG. 5, the water leakage monitoring server 100 according to the preferred embodiment of the present disclosure includes a network interface unit 110, a synchronization unit 120, an information generation unit 130, a user interface unit 140, a storage unit 150, and a control unit 160.

The network interface unit 110 supports network communications of the water leakage monitoring server 100 and can communicate with the communication unit 230 disposed in the plurality of sound detection devices 100 to realize mutual information transmission/reception. For example, the network interface unit 110 may receive the water leakage information from the sound detection device detecting the water leakage sound among the plurality of sound detection devices 200.

The synchronization unit 120 collectively synchronizes the time of the plurality of sound detection devices 200 in accordance with a predetermined period. The synchronization unit 120 uses global positioning system (GPS) to acquire time information and allows the plurality of sound detection devices 100 to have the same time information in accordance with the acquired time information.

The information generation unit 130 is configured to generate detailed water leakage information by using the water leakage information received through the network interface unit 110. More specifically, the information generation unit 130 uses the water leakage information to compute a water leakage point and marks the computed water leakage point on a stored water and sewage pipe map to generate map information. Moreover, the information generation unit 130 may include the map information in the detailed water leakage information.

Moreover, the information generation unit 130 considers the water temperature included in the water leakage information to check the speed when the water leakage sound is transferred to the sound detection device 200 and computes a difference in time when the water leakage sound is transferred to the plurality of sound detection devices 200 through cross-correlation to determine the water leakage point. Determining the water leakage point through the cross-correlation in the information generation unit 130 follows a well-known technique.

The user interface unit 140 supports interface between the water leakage monitoring server 100 and a user (or a manager) and may provide the detailed water leakage information to the user when recovery is required due to occurrence of water leakage.

The storage unit 150 stores all information required for operation of the water leakage monitoring server 100. For example, the storage unit 150 may store the water and sewage pipe map information required when the information generation unit 130 generates the detailed water leakage information.

The control unit 160 controls the overall function of the water leakage monitoring server 100. In other words, the control unit 160 controls signal input/output among the network interface unit 110, the synchronization unit 120, the information generation unit 130, the user interface unit 140, and the storage unit 150.

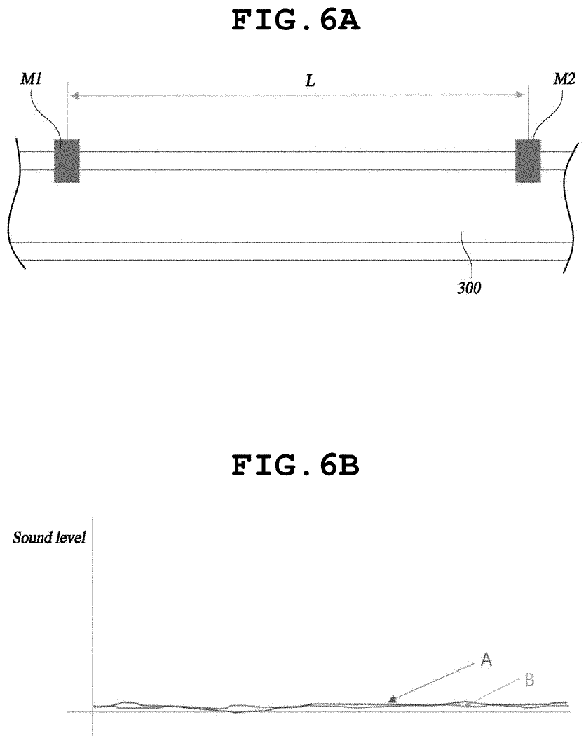

FIGS. 6A and 6B are views illustrating a state when no water leakage occurs in the water and sewage pipe.

FIG. 6A illustrates a part of the water and sewage pipe 300 in which the sound detection device 200 is installed and illustrates only a portion in which a pair of sound detection devices M1 and M2 are installed in a tunnel-like long water and sewage pipe 300. The pair of sound detection devices M1 and M2 is installed to be spaced apart at L.

FIG. 6B illustrates a graph of a sound level detected by the pair of sound detection devices M1 and M2 when water leakage does not occur in the water and sewage pipe 300.

Referring to FIG. 6B, A represents the sound level detected by the sound detection device M1 disposed on the left side in the drawing and B represents the sound level detected by the sound detection device M3 disposed on the right side in the drawing.

When the water leakage does not occur in the water and sewage pipe 300 or during nighttime when the flow of water is minimized, both the pair of sound detection devices M1 and M2 detect only the sound of a white noise level.

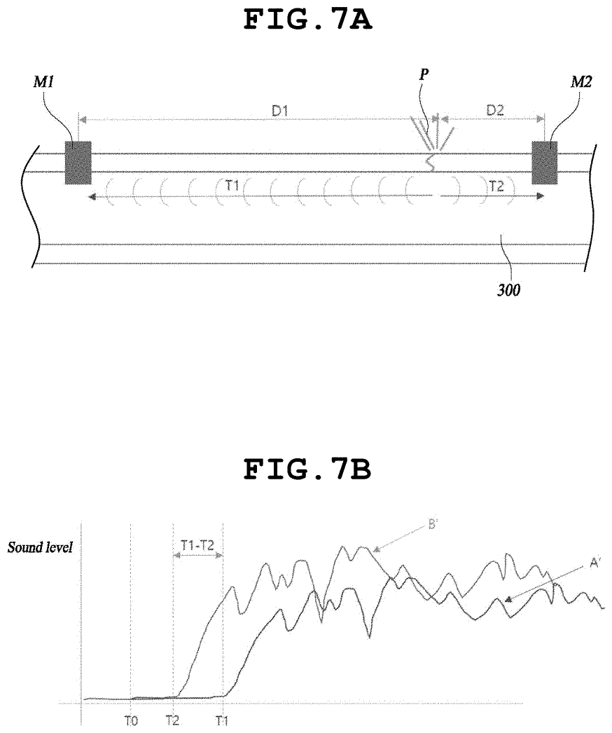

FIGS. 7A and 7B are views illustrating the state in the non-operation time of the sound detection device when water leakage occurs in the water and sewage pipe.

It is assumed that water leakage occurs in the water and sewage pipe 200 between the pair of sound detection devices M1 and M2. At this time, the pair of sound detection devices M1 and M2 does not perform water leakage monitoring operation by the water leakage monitoring system for water and sewage pipe when the pair of sound detection devices M1 and M2 is not in the operation time.

In other words, the plurality of sound detection devices 200 are set to operate only the predetermined operation time. The reason is that a time period in which water is less used is experimentally set as the operation time because the water leakage sound is not effectively measured when a large amount of water flows through the water and sewage pipe 300.

When the pair of sound detection devices M1 and M2 are spaced apart at an interval L and water leakage occurs at any point between the pair of sound detection devices M1 and M2, D1 is a distance between the sound detection device M1 and a water leakage point P and D2 is a distance between the sound detection device M2 and the water leakage point P.

When the plurality of sound detection devices 200 are in the operation time, the water leakage sound is transferred along the water and the pair of sound detection devices M1 and M2 detect the water leakage sound and generate the water leakage information. In this case, a graph in FIG. 7B may be acquired.

FIG. 7B illustrates a graph of a sound level to be detected in a situation in which the plurality of sound detection devices is always turned on. As shown, only the sound of the white noise level is detected like FIG. 7B when the water leakage does not occur in the water and sewage pipe 300 (before T0) and a high sound level is appeared as being increased from a time point T0 when the water leakage occurs.

Since distances between the water leakage point P and the pair of sound detection devices M1 and M2 are different, the sound level graph A′ of the sound detection device M1 and the sound level graph B′ of the sound detection device M2 show a time difference while having the similar shape.

T0 is the time point when the water leakage occurs, T1 is a time when the water leakage sound reaches the sound detection device M1, and T2 is a time when the water leakage sound reaches the sound detection device M2. Here, the water leakage point can be understood when T1-T2 is known. However, when the plurality of sound detection devices 200 is in a non-operation time in the present embodiment, data by the graph of FIG. 7B is not acquired.

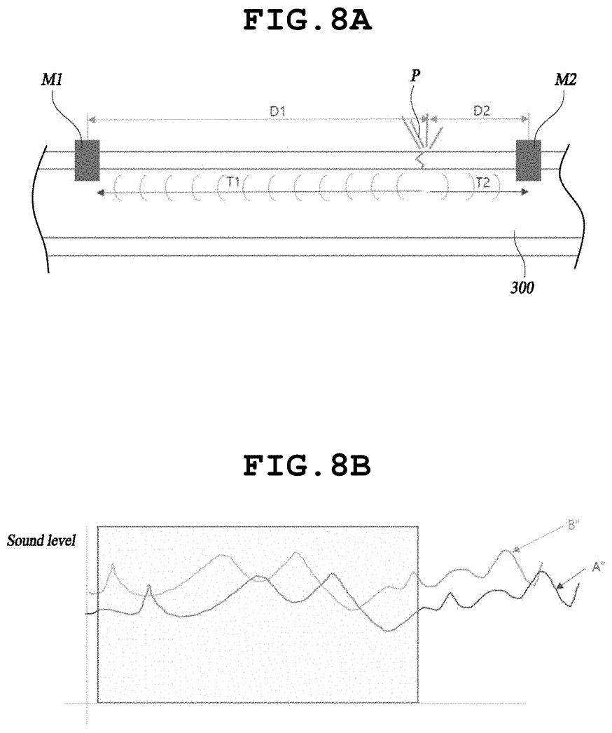

FIGS. 8A and 8B are views illustrating the state of the sound detection device in an operation time when water leakage occurs in the water and sewage pipe.

The present embodiment explains that, as an example, the system has started operation upon the operation time of the plurality of sound detection devices 200 while the water continuously leaks from the water and sewage pipe 300. The operation time of the system may set a time period, for example, 2 a.m., when most users use less water.

When the operation time of the system reaches, the controller 250 performs time synchronization used by the plurality of sound detection devices 200 through communications with the water leakage monitoring server 100 and other controllers. Since the speed of sound is very fast in water, the time synchronization between the plurality of sound detection devices 200 is important to check the correct detailed water leakage information.

As described in FIGS. 6A and 6B, the water leakage sound is transferred through the water to be detected by the pair of sound detection devices M1 and M2 when the water leakage occurs at the water leakage point P between the pair of sound detection devices 200.

A sound level of the case in which the pair of sound detection devices M1 and M2 are operated upon the operation time reaches and immediately detect the water leakage sound are represented in FIG. 8B. A″ is a sound level graph of the sound detection device M1 and B″ is a sound level graph of the sound detection device M2. Here, the pair of sound detection devices M1 and M2 start operation when the water leakage previously occurs, a sound of a water leakage level is detected from the beginning. At this time, it is important that the pair of sound detection devices M1 and M2 acquire the sound at the same time.

When the water leakage sound is detected, the sound detection device M1 records the sound of water for the predetermined recording time by the underwater sound sensor 210 and measures the water temperature by the temperature sensor 220. Then, the water leakage monitoring server 100 uses the recorded sound of water, the water temperature, and the recording time to calculate time when the water leakage sound reaches the sound detection device M1 from the water leakage point P.

Moreover, when the water leakage sound is detected, the sound detection device M2 records the sound of water for the predetermined recording time by the underwater sound sensor 210 and measures the water temperature by the temperature sensor 220. Then, the water leakage monitoring server 100 uses the recorded sound of water, the water temperature, and the recording time to calculate time when the water leakage sound reaches the sound detection device M2 from the water leakage point P.

The water leakage monitoring server 100 may check the water leakage point P when a difference between the time T1 when the water leakage sound reaches the sound detection device M1 and the time T2 when the water leakage sound reaches the sound detection device M2.

When the water leakage point P is checked, the water leakage monitoring server 100 marks the water leakage point on the stored water and sewage pipe map to generate map information. By such operation, a manager can easily check a point where the water leakage occurs by the map information and can quickly take action for the corresponding point, thereby prevent damage due to the water leakage.

Those skilled in the art to which the present disclosure pertains will understand that the present disclosure may be embodied in other specific forms without changing the technical spirit or essential characteristics thereof. Therefore, it should be understood that the embodiments described above are illustrative in all respects and not restrictive. The scope of the present disclosure is indicated by the following claims rather than the above detailed description, and all changes or modifications derived from the meaning and scope of the claims and their equivalent concepts should be interpreted as being included in the scope of the present disclosure.

National R&D Project Information

| | |
|---|---|
| Project Identification Number | 202008168 |
| Project Number | 2020003170021 |
| Government Department | Ministry of Environment |
| Project Management Institution | Korea Environmental Industry |
| | and Technology Institute |
| Research project | Green Innovation Company |
| | Growth Support |
| | Program (commercialization) |
| Research Task | IoT-based smart water |
| | management platform |
| Contribution Rate | 1/1 |
| Task Execution Institution | USOL Co., Ltd. |
| Research Period | 28 Sep. 2020.~31 Dec. 2022 |

What is claimed is:

1. A sound detection device for a water and sewage pipe, the sound detection device comprising:
an underwater sound sensor configured to detect a sound of water inside the water and sewage pipe;
a temperature sensor configured to measure a temperature of water; and
a controller configured to control the underwater sound sensor and the temperature sensor to operate during a predetermined operation time and to record the sound of water detected by the underwater sound sensor for the predetermined recording time when a water leakage sound is detected during a detection operation.

2. The sound detection device of claim 1, wherein a plurality of sound detection devices are respectively installed in the water and sewage pipe to be spaced apart from each other.

3. The sound detection device of claim 2, wherein the controller generates water leakage information including the recorded sound of water, the measured water temperature, and the recording time of the sound of water, and transmits the generated water leakage information to an external server.

4. The sound detection device of claim 1, further comprising a plurality of sub pipes having one end fixed in a hole which is formed on one side of the water and sewage pipe to be spaced apart from each other and allowing a valve to be installed at the other end.

5. The sound detection device of claim 4, wherein the sound detection device is installed at the other end of the sub pipe while the valve is closed, and the valve is left open after installation of the sound detection device.

6. A water leakage monitoring server for a water and sewage pipe, the water leakage monitoring server comprising:
a network interface unit configured to receive water leakage information from a sound detection device detecting a water leakage sound among a plurality of sound detection devices installed in the water and sewage pipe;
an information generation unit configured to generate detailed water leakage information by using the received water leakage information; and
a synchronization unit collectively synchronizing the time of the plurality of sound detection devices in accordance with a predetermined period.

7. The water leakage monitoring server of claim 6, wherein the information generation unit computes a water leakage point by using the received water leakage information, marks the computed water leakage point on a water and sewage pipe map to generate map information, and includes the generated map information in the detailed water leakage information.

8. The water leakage monitoring server of claim 6, wherein the information generation unit checks a speed when the water leakage sound is transferred to the sound detection device in consideration of a water temperature included in the water leakage information and computes a difference in time when the water leakage sound is transferred to the plurality of sound detection devices on the basis of cross-correlation to determine a water leakage point.

9. A water leakage monitoring system for a water and sewage pipe, the water leakage monitoring system comprising:
a plurality of sound detection devices installed in the water and sewage pipe to be spaced apart from each other, configured to operate for a predetermined operation time to detect a sound of water flowing inside the water and sewage pipe, and to record the sound of water for the predetermined recording time when a water leakage sound is detected during a detection operation; and
a water leakage monitoring server configured to receive water leakage information including the recorded sound of water from a pair of neighboring sound detection devices detecting the water leakage sound among the plurality of sound detection devices and to generate detailed water leakage information by using the received water leakage information.

10. The water leakage monitoring system for a water and sewage pipe of claim 9, wherein the sound detection device comprises:
an underwater sound sensor configured to detect the sound of water inside the water and sewage pipe;
a temperature sensor configured to measure a temperature of water; and
a controller configured to control the underwater sound sensor and the temperature sensor to operate during a predetermined operation time and to record the sound of water detected by the underwater sound sensor for the predetermined recording time when a water leakage sound is detected during the detection operation.

11. The water leakage monitoring system for a water and sewage pipe of claim 10, wherein the controller generates water leakage information including the recorded sound of water, the measured water temperature, and the recording time of the sound of water, and transmits the generated water leakage information to the water leakage monitoring server.

12. The water leakage monitoring system for a water and sewage pipe of claim 10, wherein the controller records the sound of water upon the predetermined recording time when the water leakage sound is detected by the underwater sound sensor.

13. The water leakage monitoring system for a water and sewage pipe of claim 9, wherein the water leakage monitoring server collectively synchronizes time of the controller in accordance with a predetermined period.

14. The water leakage monitoring system for a water and sewage pipe of claim 9, wherein the water leakage monitoring server computes a water leakage point by using the received water leakage information, marks the computed water leakage point on a water and sewage pipe map to generate map information, and includes the generated map information in the detailed water leakage information.

15. The water leakage monitoring system for a water and sewage pipe of claim 11, wherein the water leakage monitoring server checks a speed when the water leakage sound is transferred to the sound detection device in consideration of the water temperature included in the water leakage information and computes a difference in time when the water leakage sound is transferred to the plurality of sound detection devices on the basis of cross-correlation to determine a water leakage point.

16. The water leakage monitoring system for a water and sewage pipe of claim 9, further comprising a plurality of sub pipes having one end fixed in a hole which is formed on one side of the water and sewage pipe to be spaced apart from each other and allowing a valve to be installed at the other end.

17. The water leakage monitoring system for a water and sewage pipe of claim 16, wherein the sound detection device is installed at the other end of the sub pipe while the valve is closed, and the valve is left open after installation of the sound detection device.
